(19) United States
(12) Patent Application Publication
(10) Pub. No.: US 2010/0018413 A1
(43) Pub. Date: Jan. 28, 2010

(54) Turn Rod Cooking Grill

(76) Inventor: Nathaniel L. Thomas, Washington, DC (US)

Correspondence Address: PATWRITE LLC, 408 W. MAIN ST., MARSHALLTOWN, IA, 50158-5759, US

(21) Appl. No.: 12/178,009

(22) Filed: Jul. 23, 2008

(51) Int. Cl. A47J 37/07

(52) U.S. Cl. 99/421 HV; 99/421 V; 126/25 A

(57) ABSTRACT

A turn rod grill comprises a grill base having 4 legs and two wheels disposed along two adjacent legs. An upper grill grate has a plurality of slots allowing a positioning rod to move in and out. A turning shaft disposed within the positioning rod is attached to a turning knob and rotates a removable food holding fork. As the knob is turned, the fork turns in a vertical direction through the use of two beveled gears. A lower grate is provided to hold the fuel such as charcoal above the bottom allowing air to enter. The rotating collar is held in place by a retaining plate that is removeably inserted in the rotating collar. A plurality of holes in the grill base allow the turning rod to move in and out to allow the user to both rotate a food item as well as position it for optimum cooking.

### BACKGROUND OF THE INVENTION

Since humans first learned to cook their food, they have come up with many ways to control the fire. The development of the grill has evolved from a simple fire pit made with rocks to modern gas grills. Fire has been the one constant in food preparation until the advent of electricity. Of course there are electric grills and modern stoves; however, many people feel that electric grills and stoves cannot give food the flavor and taste available from food cooked with open fire.

Although flavorful, it is generally not as easy and convenient to cook food using open fire. Grills are certainly an improvement over a fire pit, but it is difficult to cook food evenly without burning over an open fire even when placed on a grill. There is a need for a grill that allows a user to control the cooking of food over an open fire that is safe and easy to use.

### SUMMARY OF THE INVENTION

A turn rod grill comprises a grill base having 4 legs and two wheels disposed along two adjacent legs. An upper grill grate has a plurality of slots allowing a positioning rod to move in and out. A turning shaft disposed within the positioning rod is attached to a turning knob and rotates a removable food holding fork. As the knob is turned, the fork turns in a vertical direction through the use of two beveled gears. A lower grate is provided to hold the fuel such as charcoal above the bottom allowing air to enter. The rotating collar is held in place by a retaining plate that is removeably inserted in the rotating collar. A plurality of holes in the grill base allow the turning rod to move in and out to allow the user to both rotate a food item as well as position it for optimum cooking.

Other features and advantages of the instant invention will become apparent from the following description of the invention which refers to the accompanying drawings.

### BRIEF DESCRIPTION OF THE DRAWINGS

FIG. 1 is a perspective view of grill according to an embodiment of the present invention.

FIG. 2 is a perspective view of grill according to an embodiment of the present invention.

FIG. 3 is a perspective view of grill according to an embodiment of the present invention.

FIG. 4 is a perspective view of grill according to an embodiment of the present invention.

FIG. 5 is a perspective view of grill according to an embodiment of the present invention.

FIG. 6 is a detail view of a turn rod according to an embodiment of the present invention.

FIG. 7 is a detail view of a portion shown in FIG. 8.

FIG. 8 is a detail view of a fork according to an embodiment of the present invention.

FIG. 9 is a perspective view of grill according to an embodiment of the present invention.

FIG. 10 is a cutaway side view of grill according to an embodiment of the present invention.

### DETAILED DESCRIPTION OF THE INVENTION

In the following detailed description of the invention, reference is made to the drawings in which reference numerals refer to like elements, and which are intended to show by way of illustration specific embodiments in which the invention may be practiced. It is understood that other embodiments may be utilized and that structural changes may be made without departing from the scope and spirit of the invention.

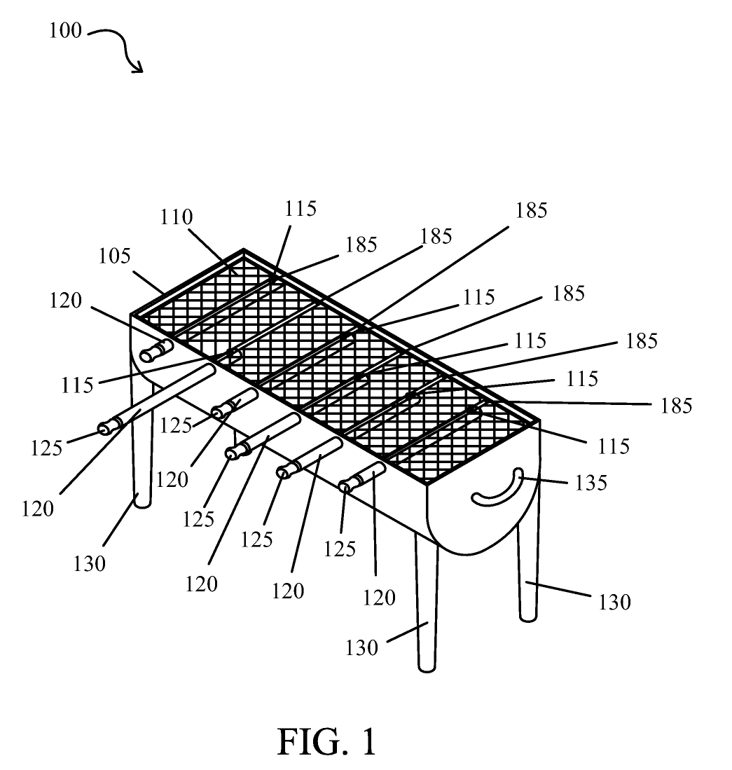

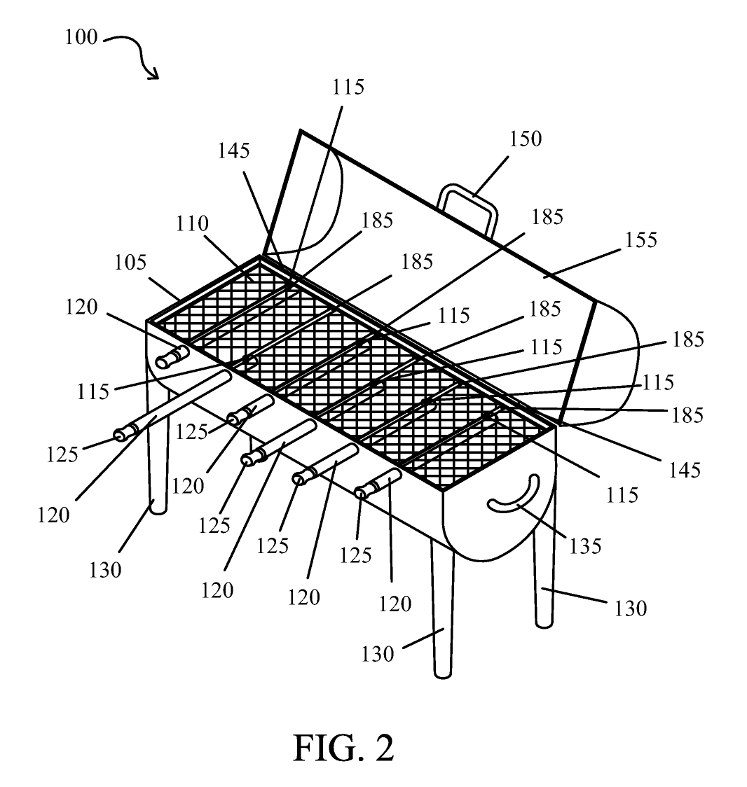

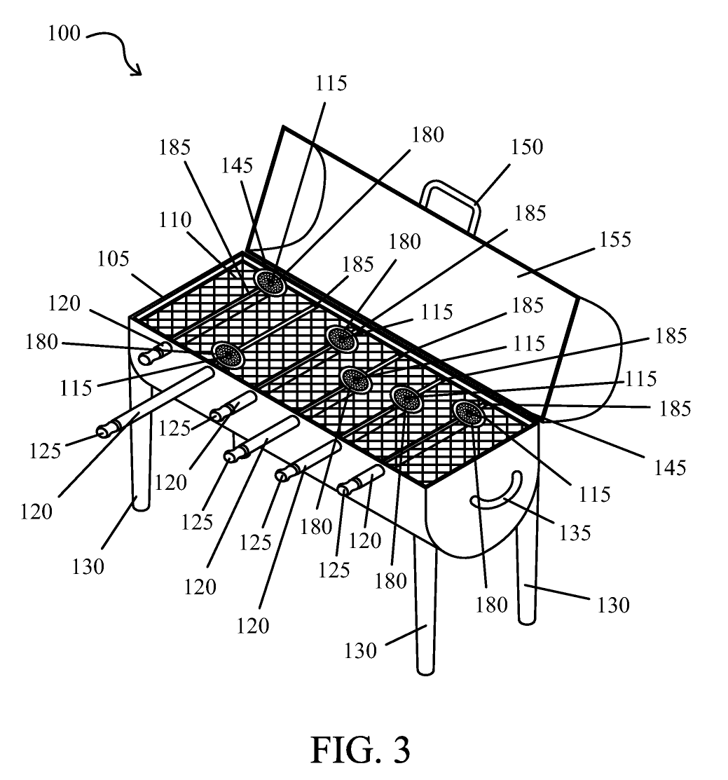

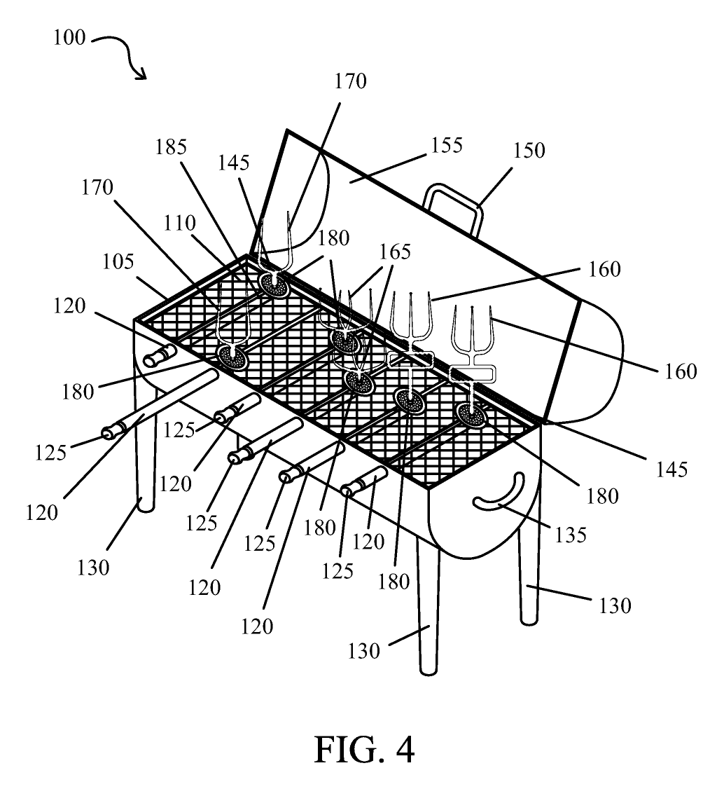

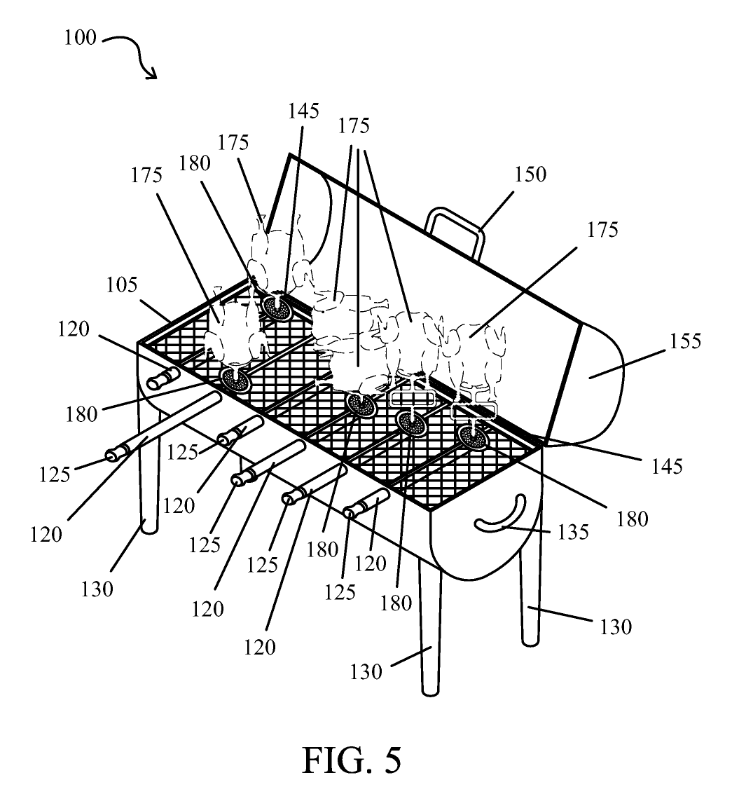

Referring to FIGS. 1 through 5, a turn rod cooking grill 100 comprises a grill base 105 with a grill grate 110. Grill base 105 has four legs 130 to support grill base 105. Of course other leg configurations are possible such as three legs (not shown) or a single pedestal type leg (not shown) as long as grill base 105 is securely supported. A plurality of positioning rods 120 are provided to position a food item 175. Each positioning rod 120 has a turning knob 125 connected to a turning shaft 195 which is operatively connected to a rotating collar 115 whereby the horizontal rotation of turning knob 125 is converted to the vertical rotation of rotating collar 115. Turning shaft 195 is rotatably held in position within positioning rod 120 using a plurality of positioners 190 which are housed in positioning rod 120. Positioners 190 may be a simple bushing collar or a bearing assembly as is known in the art.

Grill grate 110 has a plurality of slots 185 that allow rotating collar 115 to move along a path defined by slot 185. A retaining plate 180 attaches to rotating collar 115 and keeps positioning rod 120 in place and constrained to follow the path defined by slot 185.

A grill cover 155 has a handle 150 and is hingedly attached to grill base 105 with hinges 145. A plurality of forks are provided to hold various foods and are selected to best hold a selected food item 175 such as chicken depicted herein. A topside fork 170 has two tines, a cross fork 165 has four tines and an upright inside fork 160 has three tines to provide support for food item 175. Of course other holding configurations are possible as is known in the art.

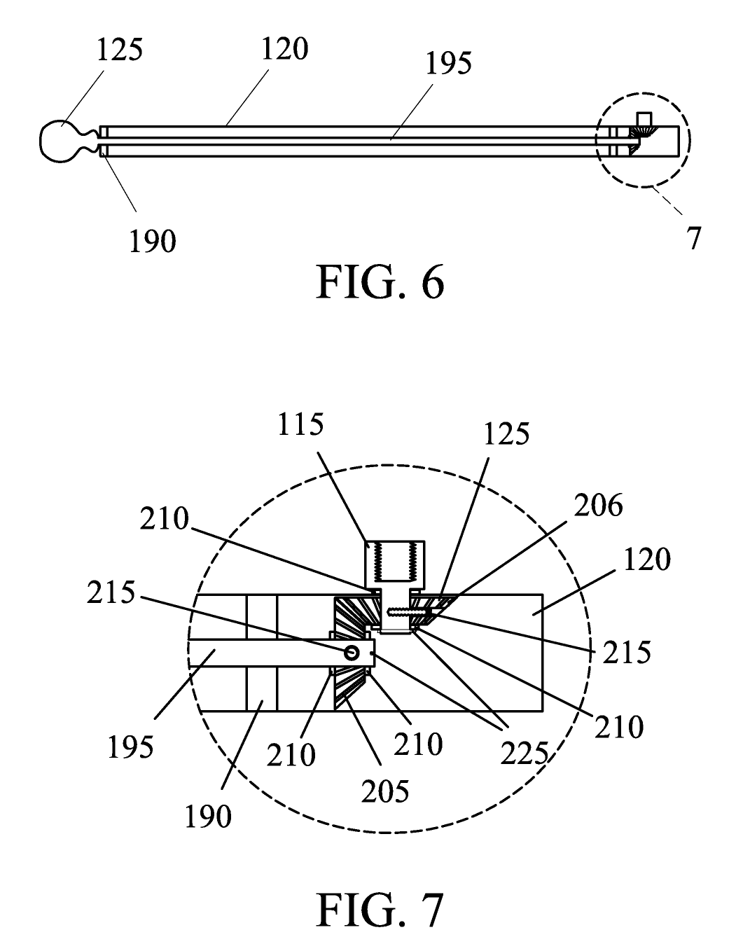

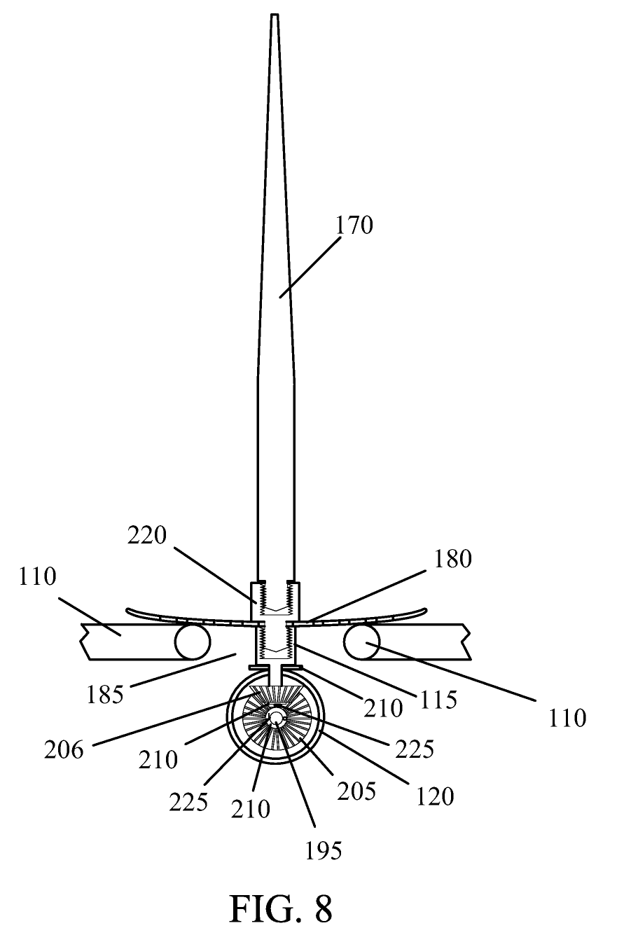

Referring now to FIGS. 6, 7 and 8, a detailed view of positioning rod 120 shows turning knob 125 attached to turning shaft 195 which is rotatably supported by positioners 190. As discussed above, positioners 190 may be bushings as shown or actual bearings. A beveled gear 205 is attached to turning shaft 195 and interacts with another beveled gear 206 to transform the horizontal rotation of turning shaft 195 to the vertical rotation of rotating collar 115. Gears 205 and 206 are held in place with retaining screws 215, retaining washers 210 and retaining pins 225 as is known in the art. Retaining plate 180 rests against slot 185 in grill grate 110. Topside fork 170 screws into a retaining plate collar 220 to keep retaining plate 180 in place by screwing into rotating collar 115.

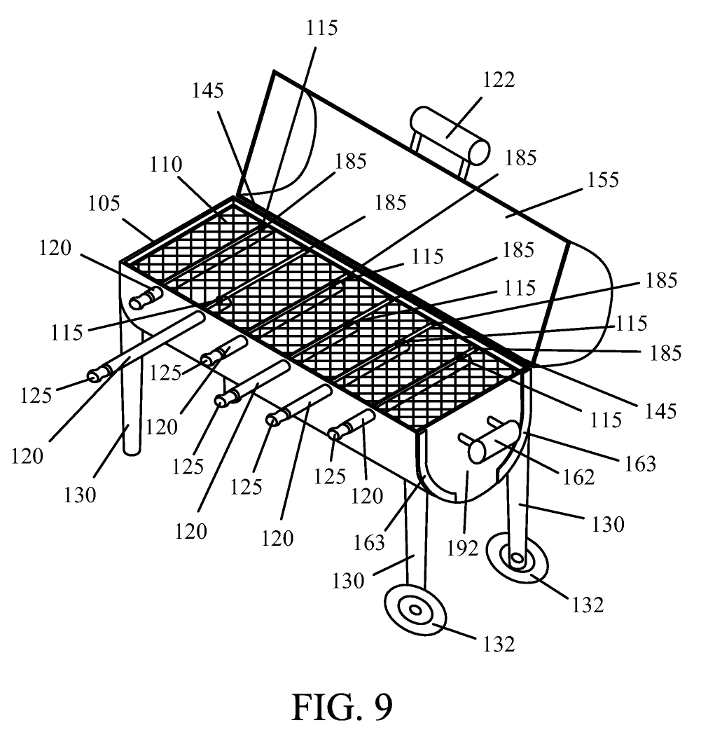

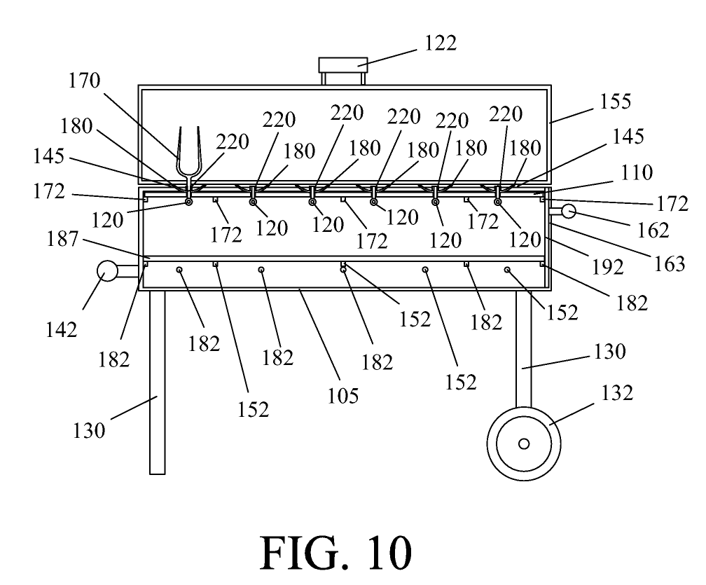

Now referring to FIGS. 9 and 10, wheels 132 are added to legs 130 to provide mobility. Two wheels 132 are shown; however other combinations are possible including 4 wheels, gliders, rotating wheels, locking wheels, etc. as is known in the art in order to enhance mobility while retaining stability. A clean out door 192 has a handle 162 and is provided to facilitate cleaning left over ash or other debris from grill. A clean out retainer slot 163 holds clean out door 192 while in use. A grill cover handle 150 is used to safely open and close grill cover 155. A handle 142 is used to safely move grill base 105. A plurality of air holes 182 are provided to allow air to reach the fuel as is known in the art.

Additionally, sliding doors (not shown) may be used to adjust the amount of air reaching the fuel. A lower grate 187 is provided to support the fuel (not shown) generally charcoal or wood to aid in air circulation therein. A plurality of upper grill grate stops 172 and lower grate stops 152 are provided to hold grill grate 110 and lower grate 187 respectively.

It should be clear that the instant invention is adaptable to other fuel sources such as propane or cooking gas, etc without departing from the essence of the invention. When a food item 175 is placed on a fork 160, 165 or 170, the food item 175 is rotatable and may be moved laterally to a hotter or cooler part of the grill to further control and enhance cooking.

Although the instant invention has been described in relation to particular embodiments thereof, many other variations and modifications and other uses will become apparent to those skilled in the art.

What is claimed is:

1. A turn rod cooking grill comprising:
a grill base having at least one support leg disposed therein;
a grate having at least one slide opening therein;
said grate being moveably disposed on said grill base whereby food is kept above a heat source disposed therein;
said grill base having at least one turning rod opening in a side portion therein; and
at least one turning rod movingly disposed within said at least one turning rod opening.

2. A turn rod cooking grill according to claim 1 further comprising;
a rotating collar disposed on a cooking end of said at least one tuning rod wherein said rotating collar is directed upward; and
a turning means for turning said rotating collar.

3. A turn rod cooking grill according to claim 2 wherein said turning means comprises a turning handle connected to a gear assembly whereby said rotating collar is rotated as said turning handle is rotated.

4. A turn rod cooking grill according to claim 1 further comprising a handle rotatably disposed on an other end of said at least one turning rod therein.

5. A turn rod cooking grill according to claim 3 further comprising a grill cover hingedly disposed along a top portion of said grill base.

6. A turn rod cooking grill according to claim 5 further comprising a retainer plate removeably disposed on said rotating collar wherein said retainer plate slides along an upper surface of said at least one slide opening.

7. A turn rod cooking grill according to claim 6 wherein said rotating collar has a retaining portion disposed therein.

8. A turn rod cooking grill according to claim 6 further comprising a cooking fork removeably disposed within said retaining portion.

9. A turn rod cooking grill according to claim 8 further comprising a cleaning panel moveably attached to an end of said grill base wherein said grill base may be cleaned.

10. A turn rod cooking grill according to claim 9 further comprising at least one wheel disposed on said at least one support leg.

11. A turn rod cooking grill according to claim 1 further comprising a lower grate disposed within said grill base wherein a fuel source rests therein.

12. A turn rod cooking grill according to claim 1 further comprising a cooking means for cooking food over said cooking grill.

13. A turn rod cooking grill according to claim 12 wherein said cooking means is charcoal.

14. A turn rod cooking grill according to claim 12 wherein said cooking means is gas.

15. A turn rod cooking grill according to claim 12 wherein said cooking means is wood.
